(19) United States
(12) Patent Application Publication
(10) Pub. No.: US 2025/0358145 A1
(43) Pub. Date: Nov. 20, 2025

(54) DATA COMMUNICATION SYSTEM, DATA COMMUNICATION METHOD, RELAY DEVICE, RELAY METHOD, AND PROGRAM

(71) Applicant: NIPPON TELEGRAPH AND TELEPHONE CORPORATION, Tokyo (JP)

(72) Inventors: Natsuki YASUHARA, Tokyo (JP); Shinichi YOSHIHARA, Tokyo (JP); Hideo KAWATA, Tokyo (JP); Hironao ABE, Tokyo (JP); Yuhei KAWAKAMI, Tokyo (JP); Takahiro KUBO, Tokyo (JP)

(73) Assignee: NIPPON TELEGRAPH AND TELEPHONE CORPORATION, Tokyo (JP)

(21) Appl. No.: 18/872,145

(22) PCT Filed: Apr. 12, 2023
(86) PCT No.: PCT/JP2023/014927

§ 371 Date: Dec. 5, 2024

(30) Foreign Application Priority Data
Jun. 7, 2022 (WO) PCT/JP2022/023016

(51) Int. Cl. H04L 12/40

(52) U.S. Cl. CPC H04L 12/4013

(57) ABSTRACT

A data communication system (1) includes: a master device that transmits a first communication frame to a slave device (20) or a relay device (30) in a first communication period; a slave device (20) that reads and writes data and transmits the first communication frame to the master device or a device at a lower stage; a relay device (30) that creates a second communication frame obtained by duplicating the received first communication frame, performs matching with an absolute time in a different communication period, transmits the second communication frame to a remote slave device (40) in a second communication period, loads the data written to the second communication frame received from the remote slave device (40) in the second communication period into the first communication frame, and transmits the first communication frame to the master device (10) or the slave device (20) in the first communication period; and a remote slave device (40) that returns, to the relay device (30), the second communication frame in which the data is read and written.

### TECHNICAL FIELD

The present disclosure relates to a data communication system, a data communication method, a relay device, a relay method, and a program that extend a data communication distance between a master and a slave in EtherCAT (registered trademark) communication.

### BACKGROUND ART

FIG. 19 is a block diagram illustrating transmission and reception of data in EtherCAT communication. As illustrated in FIG. 19, when the communication frame of EtherCAT is transmitted from a master device M-1 that controls the entire system, passes through all slave devices S-1 to S-N in the connected order, and arrives at the slave device S-N at an endpoint, the communication frame returns to the master device M-1 again by reversing the forward path.

EtherCAT can measure a time difference between transmission and return of the communication frame and perform time synchronization communication by correction from a master clock. That is, the master device writes a time to the communication frame, and each of the slave devices reads the time and calculates the time delay between the own node and the master device, and thus the time synchronization is performed.

Processing data in each of the slave devices are collectively stored (data packing) in a data section of the communication frame of EtherCAT. The slave device adopts a communication scheme of transmitting and receiving processing data (on-the-fly reading and writing) when the communication frame passes through its own node, and realizes real-time property (low latency) by transmitting the processing data in a short period.

In the EtherCAT communication, the communication frame sequentially passes through all the slave devices in one direction from the master device, the processing data is read and written in the first passing, and does not perform the processing at the time of the second passing (at the time of returning). Therefore, communication between the slave devices needs to be realized by repeating two cycles of transmission and reception of the communication frame. In the present disclosure, the communication between the slave devices is also referred to as feedback communication or FB communication. The communication between the slave devices is represented by feedback (FB) control communication. FB control refers to performing control such that an output becomes an appropriate target value or reference value by sending back an output signal to an input side. As illustrated in FIG. 19, the master device M-1 transmits the communication frame to the slave device S-1 in two cycles, consisting of a first cycle and a second cycle.

Non Patent Literature 1 describes an overview of an EtherCAT technology.

### CITATION LIST

### Non Patent Literature

Non Patent Literature 1: “EtherCAT-Ethernet Fieldbus” EtherCAT Technology Group, [online], [retrieved on May 17, 2022], the Internet <URL: https://www.ethercat.org/download/documents/ETG_Brochure_JP.pdf>

### SUMMARY OF INVENTION

### Technical Problem

FIG. 20 is a block diagram illustrating feedback (FB) control communication in EtherCAT. As illustrated in FIG. 20, in the EtherCAT communication, since period communication between the master and the slave is performed in one direction, the communication between the slave devices represented by the feedback (FB) control communication is realized by performing data transmission and reception in two cycles, consisting of the first cycle and the second cycle. Therefore, the FB communication delay depends on the communication distance between the master and the slave, and short-period FB communication with a short communication time and long-period FB communication with a long communication time cannot be mixed in the EtherCAT system. In the present disclosure, data communication performed in a short period is also referred to as short-period communication, and data communication performed in a long period is also referred to as long-period communication.

As illustrated in FIG. 20, the master device M-1 performs short-period communication with the slave devices S-1 and S-2. When data indicating that the FB control is performed on slave device S-1 is written by the slave device S-2 in the first cycle, the master device M-1 that reads the data in the communication frame that has returned transmits the communication frame in which the data is written for the slave device S-1 in the second cycle. On the other hand, as illustrated in FIG. 20, when the slave device S-3 moves to a remote place where long-period communication is necessary, the master device M-1 cannot perform short-period communication with the slave device S-3. Therefore, in a case where a processing part requiring a low latency is installed near a master device requiring a short-period response, separately from a remote control target, as in edge computing, there is no choice but to additionally construct a new master-slave system according to a communication distance by another node, and there has been a problem of economical response in the same node.

FIG. 21 is a block diagram illustrating an example of a known technology for extending data communication by IP communication between the master devices. As illustrated in FIG. 21, there coexist a master-slave system that performs short-period communication including the master device M-1 and the slave devices S-1 and S-2 that require a short-period response, and a master-slave system that performs long-period communication including the master device M-2 and the slave device S-3 to be remotely controlled. In the system of FIG. 21, the master device M-1 manages the slave devices S-1 and S-2 corresponding to the short-period communication, the master device M-2 manages the slave device S-3 that does not correspond to the short-period communication, and the master devices M-1 and M-2 perform IP communication. The specific operation of the system will be described with reference to FIG. 21.

In the master-slave system illustrated in FIG. 21, (i) when the master device M-1 first transmits the communication frame in the first cycle and the second cycle, the FB control from the slave device S-2 to the slave device S-1 is indirectly performed in the second cycle. (ii) Next, in a third cycle, the master device M-2 transmits the communication frame to the slave device S-3 installed within the range of the long-period communication, and the slave device S-3 that reads the communication frame writes data for performing FB control on the slave device S-1 and returns the data to the master device M-2. (iii) In a fourth cycle, the master devices M-2 and M-1 perform IP communication, and the data written by the slave device S-3 is transferred from the master device M-2 to the master device M-1. (iv) In a fifth cycle, when the master device M-1 transmits the communication frame including the data written by the slave device S-3 and the slave device S-1 reads the data in the communication frame, the FB control from the slave device S-3 to the slave device S-1 is performed. However, in the master-slave system illustrated in FIG. 21, there is a problem that the FB control from the slave device S-3 can be performed only once in several cycles of a short period. Moreover, it is necessary to additionally construct a new master-slave system including the master device M-2 and the slave device S-3, and there has been a problem of an economical response.

FIG. 22 is a block diagram illustrating an example of a known technology for extending data communication by bridge communication connecting the slave devices. As illustrated in FIG. 22, there coexist a master-slave system that performs short-period communication including the master device M-1 and the slave devices S-1 and S-2 that require a short-period response, and a master-slave system that performs long-period communication including the master device M-2, the slave device S-3 to be remotely controlled, and the slave device on the master device M-2 side in a bridge device B-1, and the bridge communication is performed between the slave device on the master device M-1 side in a bridge device B-1 and the slave device on the master device M-2 side. The specific operation of the system will be described with reference to FIG. 22.

In the master-slave system illustrated in FIG. 22, (i) when the master device M-1 first transmits the communication frame in the first cycle and the second cycle, the FB control from the slave device S-2 to the slave device S-1 is indirectly performed in the second cycle. (ii) Next, in a third cycle, the master device M-2 transmits the communication frame to the slave device S-3 installed within the range of the long-period communication, and the slave device S-3 that reads the communication frame writes data to the communication frame and returns the data to the master device M-2. (iii) In a fourth cycle, when the communication frame transmitted by the master device M-1 reaches the bridge device B-1 installed at the endpoint, the bridge device B-1 loads data having the same contents as the data included in the communication frame transmitted by the master device M-1 into a communication frame circulated in the master-slave system including the master device M-2, the slave device S-3, and the slave device on the master device M-2 side in the bridge device B-1, and transmits the communication frame to the slave device S-3. Then, the data in the communication frame returned from the slave device S-3 is loaded into a communication frame circulated in the master-slave system including the master device M-1 in the bridge device B-1, the slave device S-1, the slave device S-2, and the slave device on the master device M-1 side in the bridge device B-1, and is returned to the master device M-1. (iv) In a fifth cycle, when the master device M-1 transmits the communication frame including the data written by the slave device S-3, the FB control from the slave device S-3 to the slave device S-1 is indirectly performed. However, in the master-slave system illustrated in FIG. 22, there is a problem that the FB control from the slave device S-3 can be performed only once in several cycles of a short period. Moreover, it is necessary to additionally construct a new master-slave system, and there has been a problem of an economical response.

FIG. 23 is a block diagram illustrating a configuration example of the slave device. As illustrated in FIG. 23, the slave device includes an input/output unit that inputs and outputs data, a slave controller that reads and writes data addressed to the own node, and a device controller that communicates with the device.

FIG. 24 is a block diagram illustrating a configuration example of the bridge device. As illustrated in FIG. 24, the bridge device includes an input/output unit that inputs and outputs data on the short-period communication side and a slave controller that reads and writes data addressed to the own node, an input/output unit that inputs and outputs data on the long-period communication side, a slave controller that reads and writes data addressed to the own node, and a bridge that loads the data having the same content as data stored in the communication frame in the short-period communication into a communication frame in the long-period communication and loads the data having the same content as the data stored in the communication frame in the long-period communication into a frame of the short-period communication.

An object of the present disclosure made in view of such circumstances is to provide a data communication system, a data communication method, a relay device, a relay method, and a program that extend a data communication distance between a master device and a slave device by providing a relay device (proxy slave) without newly adding a master-slave system that performs long-period communication.

### Solution to Problem

In order to solve the above-described problem, according to the present embodiment, there is provided a data communication system that extends a communication distance in EtherCAT communication, the data communication system including: a master device that transmits a first communication frame in which data is stored to a slave device or a relay device in a first communication period; the slave device that reads and writes the data from and to the first communication frame and transmits the first communication frame to the master device, the slave device at a lower stage, or the relay device; the relay device that is connected to a preceding stage or a subsequent stage of the slave device, creates a second communication frame obtained by duplicating the first communication frame received from the master device or the slave device, reads and writes the data from and to the second communication frame, matches an absolute time of the relay device in the first communication period with an absolute time of a remote slave device in a second communication period, transmits the second communication frame to the remote slave device in the second communication period, loads the data written to the second communication frame received by the remote slave device in the second communication period into the first communication frame, and transmits the first communication frame to the master device or the slave device in the first communication period; and the remote slave device that reads and writes the data from and to the second communication frame received from the relay device, and returns the second communication frame to the relay device.

In order to solve the above-described problem, according to the present embodiment, there is provided a data communication method for extending a communication distance in EtherCAT communication, the data communication method including: by a master device, a step of transmitting a first communication frame in which data is stored to a slave device or a relay device in a first communication period; by the slave device, a step of reading and writing the data from and to the first communication frame; by the slave device, a step of transmitting the first communication frame to the master device, the slave device at a subsequent stage, or the relay device; by the relay device, a step of creating a second communication frame obtained by duplicating the first communication frame received from the master device or the slave device; by the relay device, a step of reading and writing the data from and to the second communication frame; by the relay device, a step of matching an absolute time of the relay device in the first communication period with an absolute time of a remote slave device in a second communication period; by the relay device, a step of transmitting the second communication frame to the remote slave device in the second communication period; by the remote slave device, a step of reading and writing the data from and to the second communication frame received from the relay device; by the remote slave device, a step of returning the second communication frame to the relay device; and by the relay device, a step of loading the data written to the second communication frame received by the remote slave device in the second communication period into the first communication frame, and transmitting the first communication frame to the master device or the slave device in the first communication period.

In order to solve the above-described problem, according to the present embodiment, there is provided a relay device that relays communication in different communication periods in EtherCAT communication, the relay device including: a duplication unit that creates a second communication frame obtained by duplicating received first communication frame; and a first control unit that reads and writes data stored in the second communication frame, matches an absolute time of the relay device in a first communication period with an absolute time of a remote slave device in a second communication period, loads the data written to the second communication frame received from the remote slave device in the second communication period into the first communication frame, and transmits the first communication frame to a master device or a slave device in the first communication period.

In order to solve the above-described problem, according to the present embodiment, there is provided a program causing a computer to function as the above-described relay device.

### Advantageous Effects of Invention

According to the present disclosure, it is not necessary to newly add a master-slave system that performs long-period communication, and thus it is possible to reduce the device cost (initial cost and running cost) in the total system.

### BRIEF DESCRIPTION OF DRAWINGS

FIG. 1 is a block diagram illustrating a configuration example of a data communication system according to a first embodiment.

FIG. 2 is a block diagram illustrating a configuration example of a relay device according to the first embodiment.

FIG. 3 is a flowchart illustrating an example of a data communication method executed by the data communication system according to the first embodiment.

FIG. 4 is a flowchart illustrating an example of a relay method executed by a relay device according to the first embodiment.

FIG. 5 is a block diagram illustrating a configuration example of a data communication system according to a second embodiment.

FIG. 6 is a block diagram illustrating a configuration example of a relay device according to the second embodiment.

FIG. 7 is a diagram illustrating a database managed by a slave management unit according to the second embodiment.

FIG. 8 is a block diagram illustrating a configuration example of a data communication system according to a third embodiment.

FIG. 9 is a block diagram illustrating a configuration example of a relay device according to the third embodiment.

FIG. 10 is a diagram illustrating a database managed by a slave management unit according to the third embodiment.

FIG. 11 is a block diagram illustrating a configuration example of a data communication system according to a fourth embodiment.

FIG. 12 is a block diagram illustrating a configuration example of a data communication system according to a fifth embodiment.

FIG. 13 is a diagram illustrating a conversion device that converts a communication protocol between EtherCAT and a communication network capable of time synchronization communication.

FIG. 14 is a block diagram illustrating a configuration example of a pair of conversion devices.

FIG. 15 is a block diagram illustrating a configuration example of a data communication system according to a sixth embodiment.

FIG. 16 is a block diagram illustrating a configuration example of a data communication system according to a seventh embodiment.

FIG. 17 is a block diagram illustrating a configuration example of a data communication system according to an eighth embodiment.

FIG. 18 is a block diagram illustrating a schematic configuration of a computer functioning as the relay device.

FIG. 19 is a block diagram illustrating transmission and reception of data in EtherCAT communication.

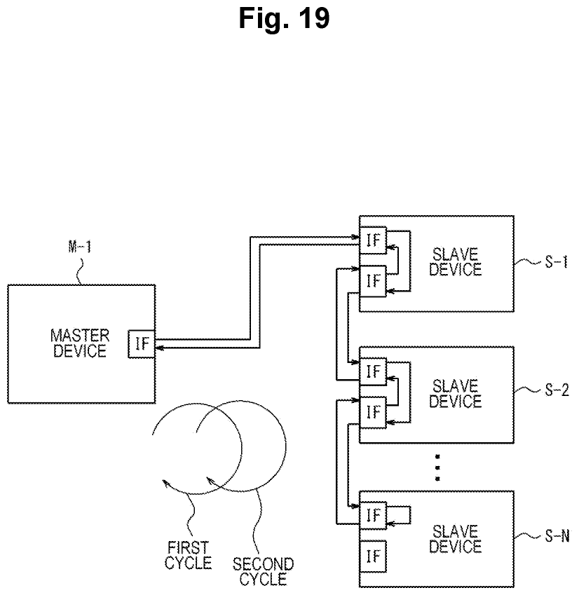

FIG. 20 is a block diagram illustrating FB control communication in EtherCAT.

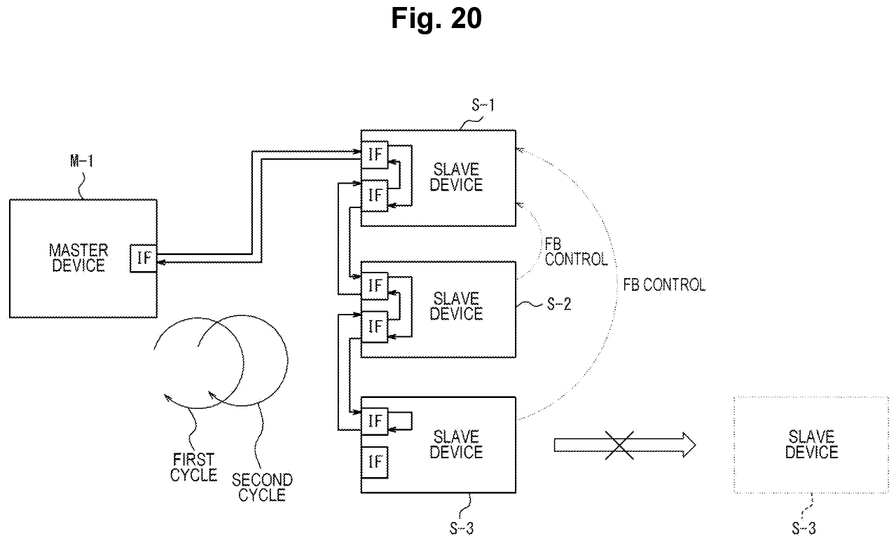

FIG. 21 is a block diagram illustrating an example of a known technology for extending a communication distance by IP communication between master devices.

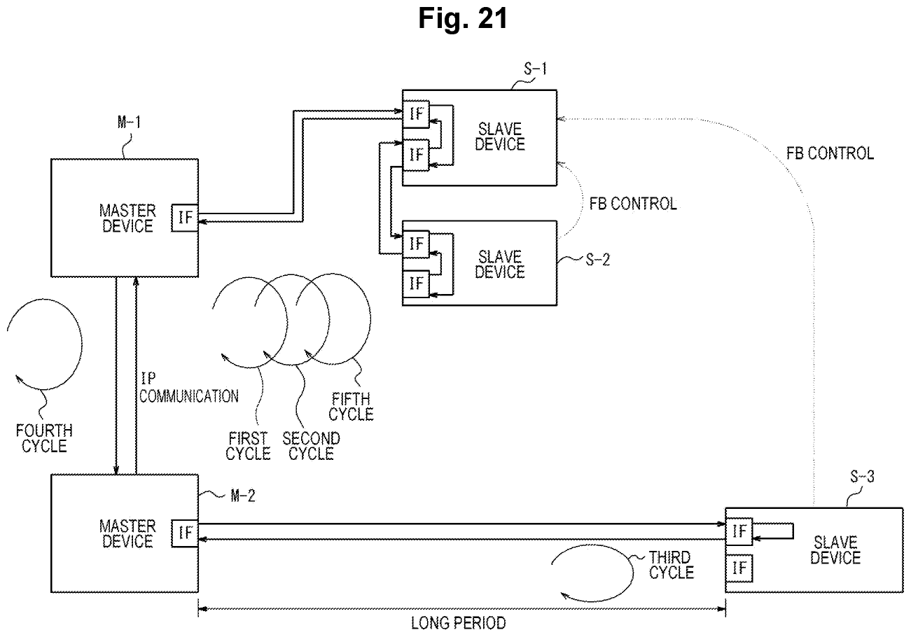

FIG. 22 is a block diagram illustrating an example of a known technology for extending a communication distance by bridge communication connecting slave devices.

FIG. 23 is a block diagram illustrating a configuration example of a slave device.

FIG. 24 is a block diagram illustrating a configuration example of a bridge device.

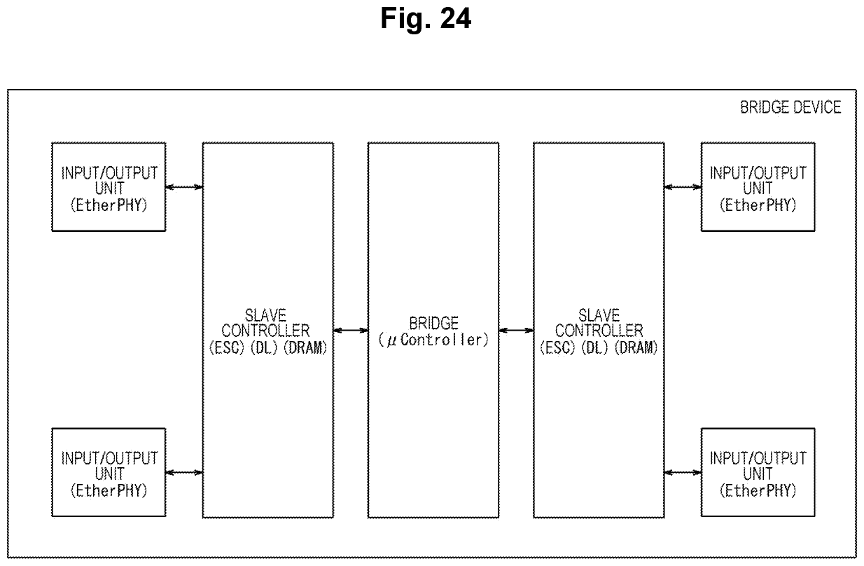

### DESCRIPTION OF EMBODIMENTS

Hereinafter, modes for carrying out the present disclosure will be described in detail with reference to the drawings. The present disclosure is not limited to the embodiment described below, and various modifications can be made within the scope of the gist of the present disclosure.

### First Embodiment

### <Data Communication System>

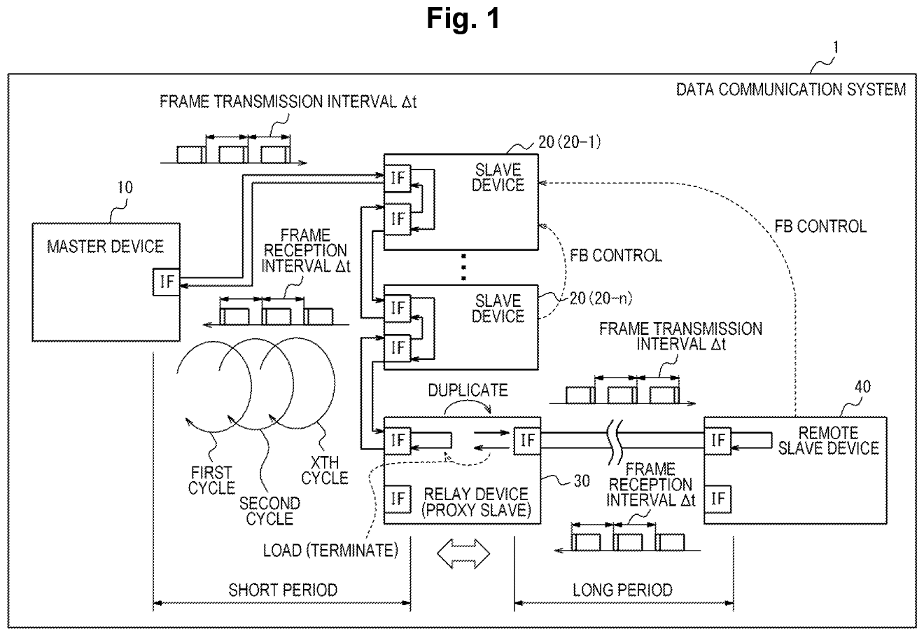

FIG. 1 is a block diagram illustrating a configuration example of a data communication system 1 according to a first embodiment. As illustrated in FIG. 1, the data communication system 1 includes a master device 10, slave devices 20 (20-1 to 20-n), a relay device 30, and a remote slave device 40. The slave devices 20 (20-1 to 20-n) can include one or more slave devices. The remote slave device 40 and the slave devices 20 have the same function. Furthermore, since one or more remote slave devices 40 can be installed, the remote slave devices 40 are also referred to as remote slave devices 40-1 to 40-m. The data communication system 1 extends a communication distance between a master device and a slave device in EtherCAT communication.

The master device 10 transmits a first communication frame in which data is stored to the slave devices 20 (20-1 to 20-n) or the relay device 30 in a first communication period. In the present disclosure, the first communication period refers to a short period, that is, a time until the first communication frame transmitted from an output unit (IF) of the master device 10 is received by an input unit (IF) of the master device 10 via the slave devices 20 and the like. The first communication frame refers to a communication frame which the master device 10 transmits to each of the slave devices 20 (20-1 to 20-n). When starting a first cycle, a second cycle, . . . , and the Xth cycle, the master device 10 transmits the first communication frame to a highest-level slave device 20-1 of the slave devices 20 (20-1 to 20-n).

As illustrated in FIG. 1, the master device 10 repeatedly transmits the first communication frame in a plurality of cycles (first cycle, second cycle, . . . , Xth cycle). As described above, in the EtherCAT communication, the communication frame sequentially passes through all the slave devices 20 in one direction from the master device 10, the processing data is read and written in a first passing, and does not perform the processing at the time of the second passing (at the time of returning). Therefore, the communication between arbitrary slave devices of the slave devices 20 is performed in the second cycle, that is, by repeating the transmission of the communication frame at least in two cycles. On the other hand, an X cycle is required to perform communication between the remote slave device 40 that performs long-period communication to be described later and a plurality of the slave devices 20 that perform short-period communication. The reason why the X cycle is required is that the time spent in one period communication (transmission and reception of data) between the relay device 30 and the remote slave device 40 that perform long-period communication depends on the communication distance, and thus it cannot be specified how many cycles the master device 10 transmits the communication frame during that time. Therefore, the communication between the remote slave device 40 and any slave device of a plurality of the slave devices 20 is performed in the Xth cycle. Note that although X cycles are required until the first time of the FB control based on information from the remote slave device 40, thereafter, the FB control based on the information from the remote slave device 40 can be performed in a short-period cycle.

The slave device 20 is configured by connecting one or more slave devices 20-1 to 20-n. When receiving the first communication frame transmitted from the master device 10 or the relay device 30, the slave device 20 reads and writes data from and to the first communication frame, and transmits the first communication frame to the master device 10, the slave device 20 at the lower stage, or the relay device 30.

The relay device (also referred to as a proxy slave) 30 is connected to a preceding stage or a subsequent stage of the slave device 20 (20-1 to 20-n). The relay device 30 (i) creates a second communication frame obtained by duplicating the first communication frame received from the master device 10 or the slave device 20, (ii) reads and writes data from and to the second communication frame, (iii) matches an absolute time of the relay device 30 in the first communication period with an absolute time of the remote slave device 40 in a second communication period, (iv) transmits the second communication frame to the remote slave device 40 in the second communication period, and (v) loads the data written to the second communication frame received from the remote slave device 40 in the second communication period into the first communication frame and returns the first communication frame to the master device 10 in the first communication period. In the present disclosure, the second communication period refers to a long period, that is, a time until the second communication frame transmitted from the output unit (IF) of the slave device on the remote slave device 40 side of the relay device 30 is received by the output unit (IF) of the slave device on the remote slave device 40 side of the relay device 30 via the remote slave device 40. The second communication frame refers to a communication frame created by the relay device 30 duplicating the first communication frame. The relay device 30 corrects the absolute time of the remote slave device 40 in the second communication period, which is longer than the first communication period, to the absolute time of the relay device 30 in the first communication period, transmits the corrected absolute time to the master device 10, and matches the absolute time of the relay device 30 in the first communication period with the absolute time of the remote slave device 40 in the second communication period. By matching the absolute times, the relay device 30 can relay communication between the first communication period and the second communication period. The relay device 30 transmits the second communication frame storing the data to the remote slave device 40 installed within the range communicable in the second communication period.

Remote slave devices 40 (40-1 to 40-m) read and write data from and to the second communication frame received from the relay device 30, and returns the second communication frame in which the reading and writing of the data are completed to the relay device 30. The remote slave devices 40 (40-1 to 40-m) are installed at remote places where communication cannot be performed in the first communication period, and perform communication with the relay device 30 in the second communication period that is longer than the first communication period. The remote slave devices 40 (40-1 to 40-m) and each slave device of a plurality of the slave devices 20 (20-1 to 20-n) have the same function.

### <Relay Device>

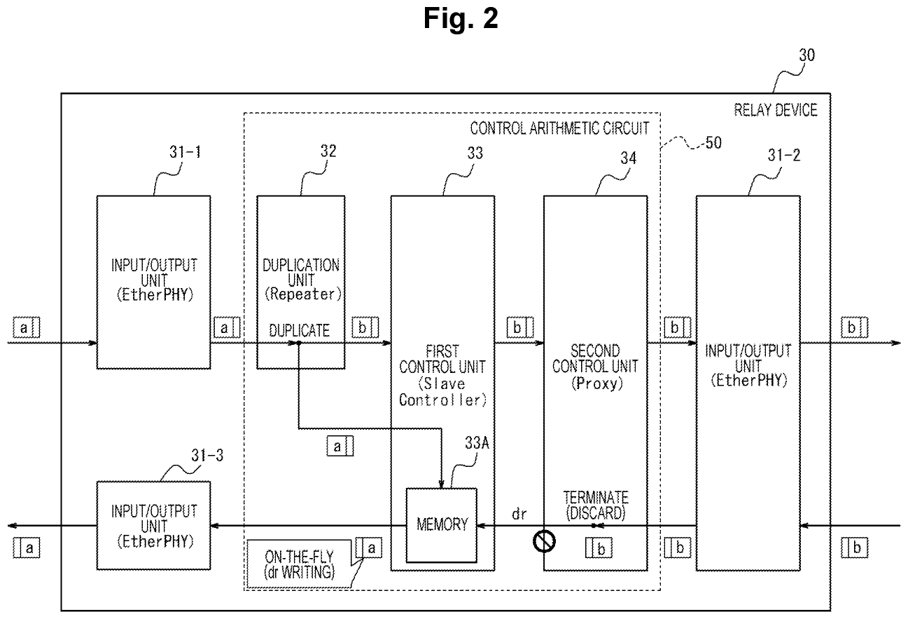

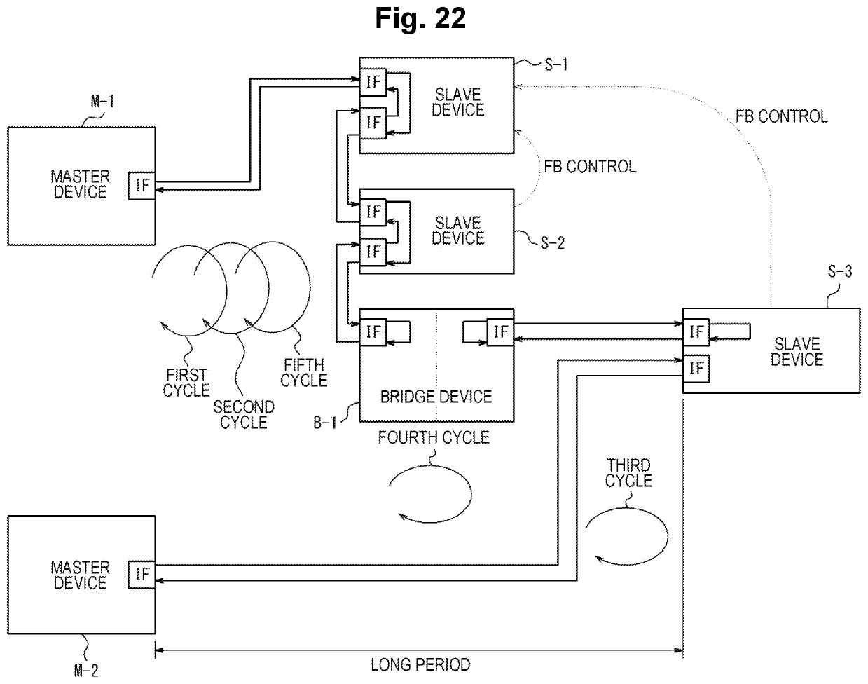

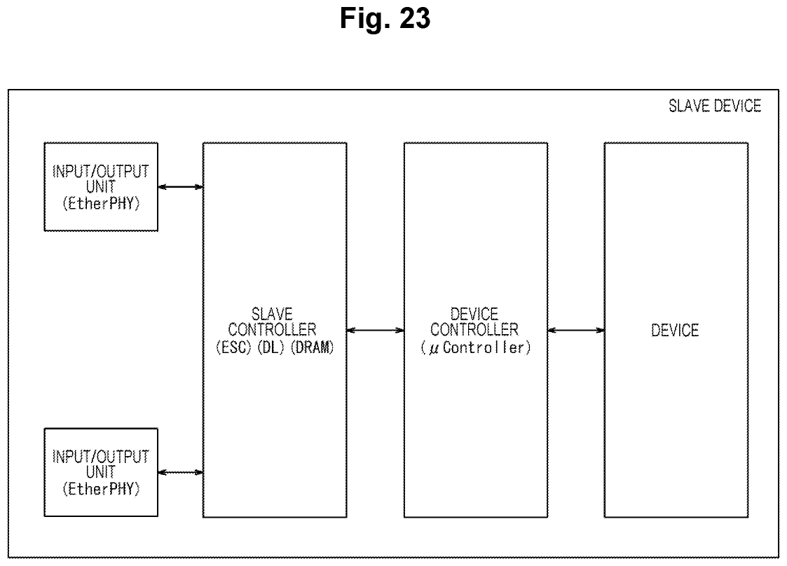

FIG. 2 is a block diagram illustrating a configuration example of the relay device 30 according to the first embodiment. As illustrated in FIG. 2, the relay device 30 includes input/output units 31 (31-1 to 31-3), a duplication unit 32, a first control unit 33, and a second control unit 34. The relay device 30 relays communication in different communication periods in the EtherCAT communication. As compared with the block diagram of the slave device of the related art illustrated in FIG. 22 or the block diagram of the bridge device of the related art illustrated in FIG. 23, a significant difference is that the relay device 30 includes a duplication unit (repeater) 32. In the present disclosure, the relay device 30 will be described as being connected to the subsequent stage of a plurality of the slave devices 20. However, the relay device 30 only needs to be disposed within a range in which the short-period communication can be performed between the master device 10 and a plurality of the slave devices 20 connected to the master device 10, and may be disposed at the preceding stage or the subsequent stage of each of the slave devices 20. The duplication unit 32, the first control unit 33, and the second control unit 34 constitute a control arithmetic circuit (controller) 50. The control arithmetic circuit 50 may be configured by dedicated hardware such as an application specific integrated circuit (ASIC) or a field-programmable gate array (FPGA), may be configured by a processor, or may be configured to include both.

The input/output units 31 (31-1 to 31-3) input and output the first communication frame or the second communication frame between the master device 10 and the slave device 20 or the remote slave device 40. The input/output units 31 (31-1 to 31-3) include a physical layer transceiver device (EtherPHY) for transmitting and receiving an Internet frame (communication frame).

The duplication unit 32 creates a second communication frame b obtained by duplicating the received first communication frame a. The duplication unit 32 outputs the first communication frame a and the duplicated second communication frame b to the first control unit.

The first control unit 33 (i) reads and writes the data stored in the second communication frame b, (ii) matches the absolute time of the relay device 30 in the first communication period with the absolute time of the remote slave device 40 in the second communication period, and (iii) outputs the second communication frame b to the second control unit 34 at the subsequent stage. Moreover, the first control unit 33 (iv) receives data dr described in the second communication frame b which the second control unit 34 receives from the remote slave device 40 in the second communication period to store the data dr in a memory 33A, and (v) loads the data dr into the first communication frame a received from the duplication unit 32. Then, the first control unit 33 (vi) transmits, to the input/output unit 31-2, the first communication frame a in which the data dr is written, and transmits the first communication frame a to the master device 10 or the slave device 20 in the first communication period.

The second control unit 34 transmits and receives the second communication frame b to and from the remote slave device 40 at the subsequent stage via the input/output unit 31-2 in the second communication period instead of the slave device 20 that transmits and receives data in the first communication period. The second control unit 34 controls processing with the remote slave device 40 that is an external device. Then, when receiving the second communication frame b from the remote slave device 40, the second control unit 34 transmits, to the first control unit 33, the data dr written to the second communication frame b, and terminates (discards) the second communication frame b.

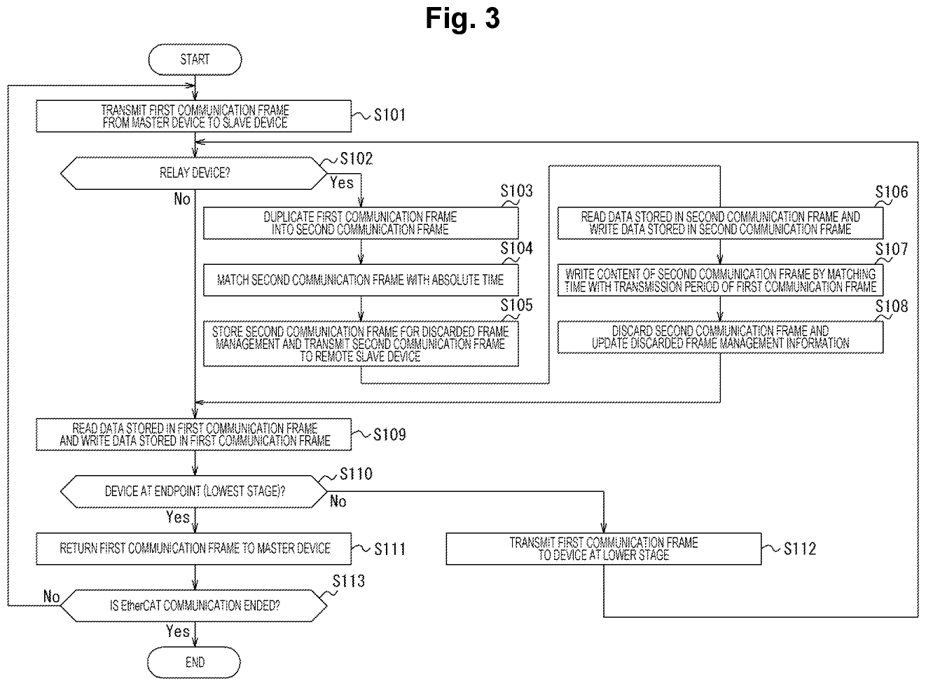

FIG. 3 is a flowchart illustrating an example of a data communication method executed by the data communication system 1 according to the first embodiment. Note that the following steps S101 to S113 are data communication methods executed by the data communication system 1 in each cycle of the transmission cycles (first cycle, second cycle, . . . , or Xth cycle) of the communication frame.

In step S101, the master device 10 transmits the first communication frame to the highest-level slave device 20-1 or the relay device 30.

In step S102, it is determined whether or not the device that receives the first communication frame from the master device 10 is the relay device 30. In a case where the device is the relay device 30, the processing proceeds to step S103. In a case where the device is the slave device 20, the processing proceeds to step S109. In step S103, the relay device 30 duplicates the received first communication frame to create a second communication frame.

In step S104, the relay device 30 matches the absolute time of the relay device 30 in the first communication period with the absolute time of the remote slave device 40 in the second communication period.

In step S105, the relay device 30 stores the second communication frame for discarded frame management, and transmits the second communication frame to the remote slave device 40 via the second control unit 34.

In step S106, the remote slave device 40 performs reading of the data stored in the second communication frame and writing to the data stored in the second communication frame.

In step S107, the relay device 30 writes the data dr (content) written to the second communication frame to the memory 33A by matching the time with the transmission period of the first communication frame.

In step S108, the relay device 30 discards the second communication frame and updates discarded frame management information.

In step S109, the slave device 20 performs reading of the data stored in the first communication frame and writing to the data stored in the first communication frame, and the relay device 30 writes the data dr written to the memory 33A to the first communication frame on the fly.

In step S110, it is determined whether or not the slave device 20 or the relay device 30 is the device at the endpoint (at the last stage). In a case where the slave device 20 or the relay device 30 is the device at the endpoint, the processing proceeds to step S111. In a case where the slave device 20 or the relay device 30 is not the device at the endpoint, the processing proceeds to step S112.

In step S111, the slave device 20 or the relay device 30 returns the first communication frame to the master device 10.

In step S112, the slave device 20 or the relay device 30 transmits the first communication frame to the device at the lower stage.

In step S113, the master device 10 reads the returned first communication frame and determines whether or not the EtherCAT communication is ended. In a case where it is determined that the EtherCAT communication is not ended, the processing returns to step S101, and in a case where it is determined that the EtherCAT communication is ended, the period communication is ended.

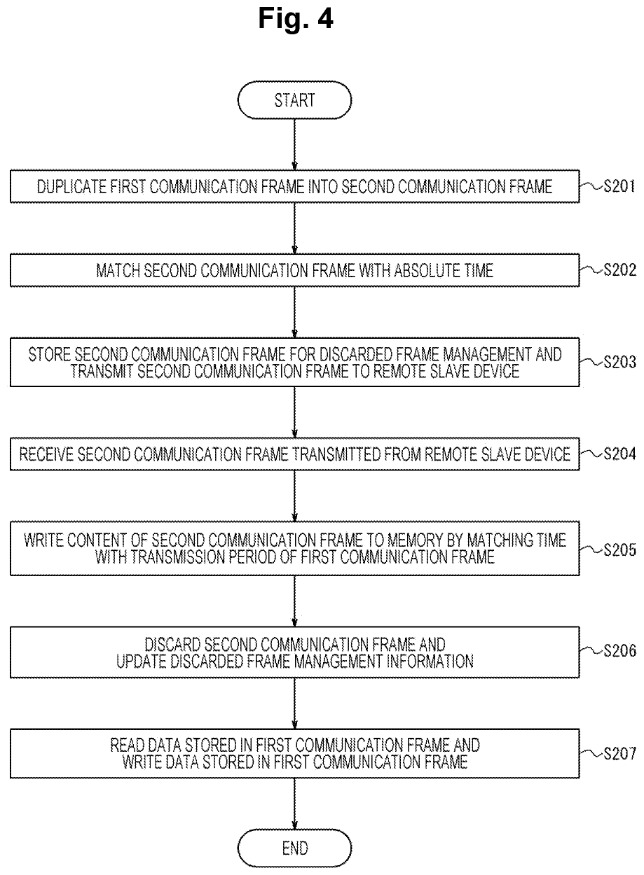

FIG. 4 is a flowchart illustrating an example of the relay method executed by the relay device 30 according to the first embodiment. The flowchart of FIG. 4 more specifically describes the main relay method executed by the relay device 30 described in steps S103 to S109 in the flowchart of FIG. 3.

In step S201, the duplication unit 32 of the relay device 30 duplicates the received first communication frame to create a second communication frame.

In step S202, the first control unit 33 of the relay device 30 matches the absolute time of the relay device 30 in the first communication period with the absolute time of the remote slave device 40 in the second communication period.

In step S203, the first control unit 33 of the relay device 30 stores the second communication frame for discarded frame management, and transmits the second communication frame to the remote slave device 40 via the second control unit 34.

In step S204, the second control unit 34 of the relay device 30 receives the second communication frame transmitted from the remote slave device 40.

In step S205, the first control unit 33 of the relay device 30 writes the data dr (content) written to the second communication frame to the memory 33A by matching the time with the transmission period of the first communication frame.

In step S206, the first control unit 33 of the relay device 30 discards the second communication frame and updates discarded frame management information.

In step S207, the first control unit 33 of the relay device 30 writes the data dr written to the memory 33A to the first communication frame on the fly.

In the data communication system 1 according to the first embodiment, it is not necessary to newly add a master-slave system that performs long-period communication, and thus it is possible to reduce the device cost (initial cost and running cost) in the total system. Furthermore, although X cycles are required until the first time of the FB control based on information from the remote slave device 40, thereafter, the FB control based on the information from the remote slave device 40 can be performed in a short-period cycle.

### Second Embodiment

### <Data Communication System>

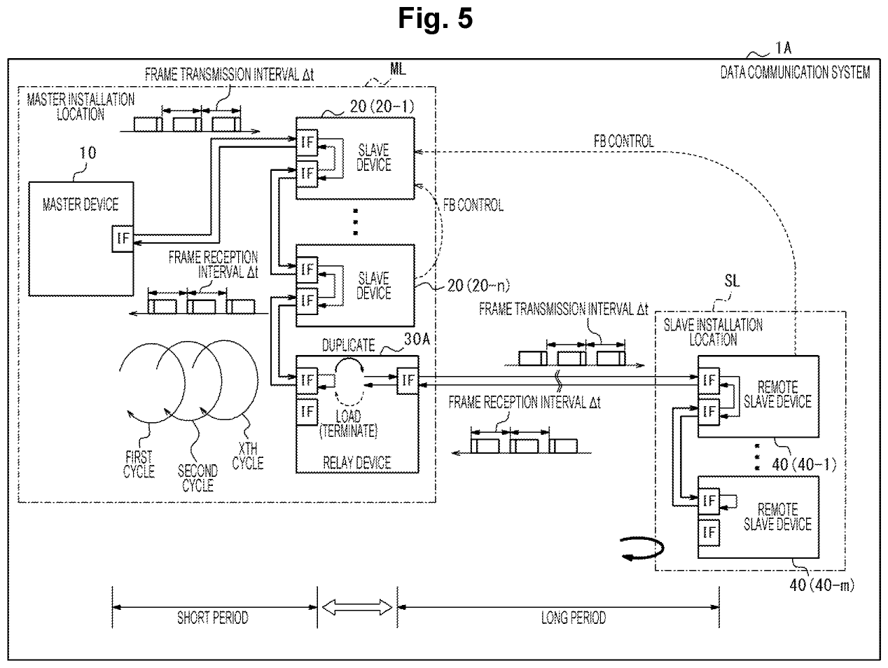

FIG. 5 is a block diagram illustrating a configuration example of a data communication system 1A according to a second embodiment. As illustrated in FIG. 5, the data communication system 1A includes a master device 10, slave devices 20 (20-1 to 20-n), a relay device 30A, and remote slave devices 40 (40-1 to 40-m). Since one or more remote slave devices 40 can be installed, the remote slave devices 40 are also referred to as remote slave devices 40-1 to 40-m. The data communication system 1A according to the present embodiment is different from the data communication system 1 according to the first embodiment in that one relay device 30A relays data communication with two or more remote slave devices 40-1 to 40-m installed within a range (slave installation location SL in FIG. 5) capable of performing short-period communication with each other. The same components as those of the first embodiment will be denoted by the same reference signs as those of the first embodiment, and the description thereof will be omitted as appropriate.

### <Relay Device>

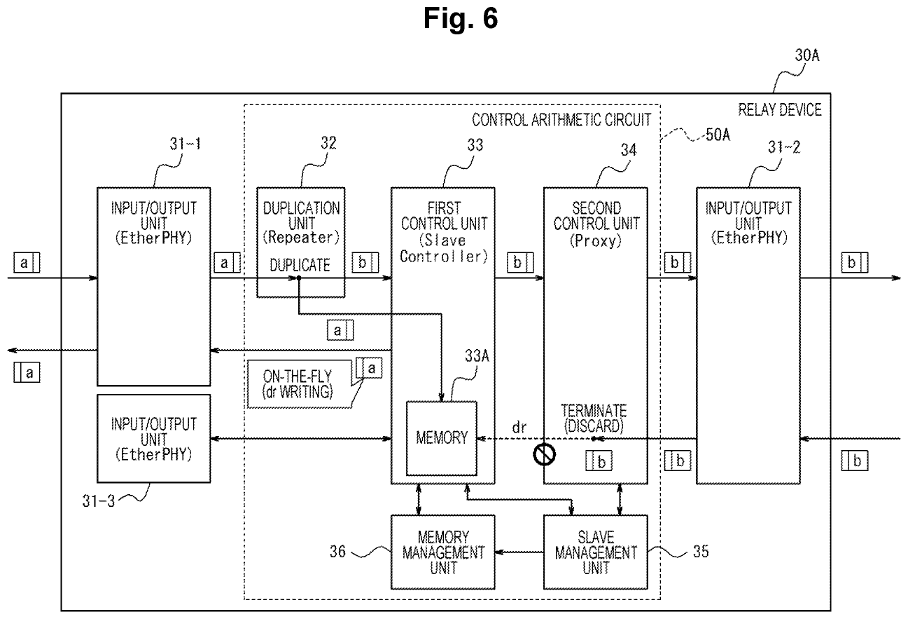

FIG. 6 is a block diagram illustrating a configuration example of the relay device 30A according to the second embodiment. As illustrated in FIG. 6, the relay device 30A includes input/output units 31 (31-1 to 31-3), a duplication unit 32, a first control unit 33, a second control unit 34, a slave management unit 35, and a memory management unit 36. The relay device 30A according to the present embodiment is different from the relay device 30 according to the first embodiment in further including the slave management unit 35 and the memory management unit 36. The same components as those of the first embodiment will be denoted by the same reference signs as those of the first embodiment, and the description thereof will be omitted as appropriate. The duplication unit 32, the first control unit 33, and the second control unit 34, the slave management unit 35, and the memory management unit 36 constitute a control arithmetic circuit (controller) 50A. The control arithmetic circuit 50A may be constituted by dedicated hardware such as ASIC or FPGA, may be constituted by a processor, or may include both dedicated hardware and a processor.

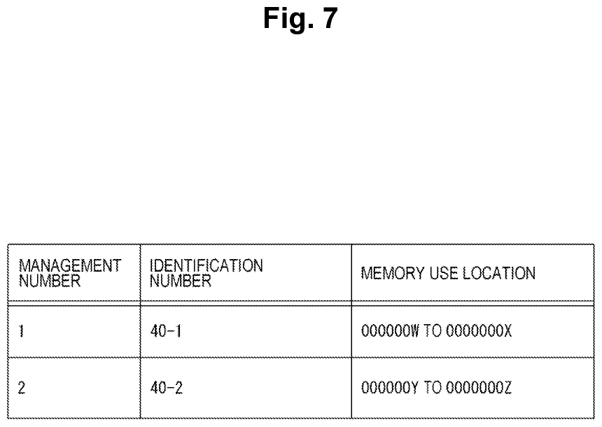

The slave management unit 35 is connected to two or more remote slave devices 40-1 to 40-m, and manages a memory use location on the memory 33A assigned to each of two or more remote slave devices 40-1 to 40-m. FIG. 7 is a diagram illustrating a database managed by the slave management unit 35. As illustrated in FIG. 7, for example, in a case where two remote slave devices 40-1 and 40-2 are installed, each management number, the identification numbers of the remote slave devices 40, and the memory use location are managed, but the data to be managed is not limited thereto. For example, the slave management unit 35 may store the database in a storage area included therein, but the present disclosure is not limited thereto. The slave management unit 35 transmits, to the memory management unit 36, the memory use location on the memory 33A assigned to each of two or more remote slave devices 40-1 to 40-m.

The memory management unit 36 receives the memory use location assigned to each of two or more remote slave devices 40-1 to 40-m from the slave management unit 35. The memory management unit 36 instructs the first control unit 33 to write and read the data received from each of two or more remote slave devices 40-1 to 40-m at the memory use location on the memory 33A. For example, the first control unit 33 writes the data dr written to the second communication frame by the remote slave device 40-1 to the memory use location on the memory 33A assigned to the remote slave device 40-1. Moreover, the first control unit 33 reads the data dr from the memory 33A, loads the data dr into the first communication frame, and transmits the first communication frame.

In the data communication system 1A according to the second embodiment, the relay device 30A includes the slave management unit 35 and the memory management unit 36. Thus, even in a case where two or more remote slave devices 40-1 to 40-m are connected at the installation location (slave installation location SL) of the remote slave device 40-1 to be controlled by the relay device 30A, the master device 10 can perform EtherCAT communication with two or more remote slave devices 40-1 to 40-m.

### Third Embodiment

### <Data Communication System>

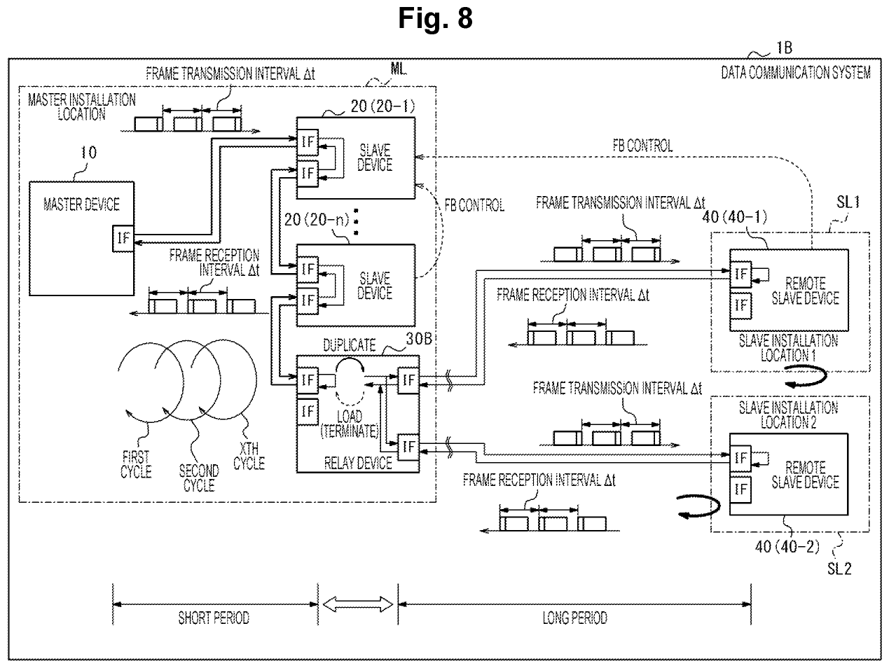

FIG. 8 is a block diagram illustrating a configuration example of a data communication system 1B according to a third embodiment. As illustrated in FIG. 8, the data communication system 1B includes a master device 10, slave devices 20 (20-1 to 20-n), a relay device 30B, and remote slave devices 40 (40-1 and 40-2). The data communication system 1B according to the present embodiment is different from the data communication system 1A according to the second embodiment in that one relay device 30B relays data communication with two remote slave devices 40-1 and 40-2 installed at locations (slave installation location SL1 and SL2 in FIG. 8) where short-period communication cannot be performed with each other. FIG. 8 illustrates an example in which two remote slave devices 40-1 and 40-2 are installed at the slave installation locations SL1 and SL2, respectively. However, three or more remote slave devices 40 (40-1 to 40-m) may be installed at locations (slave installation locations SL1 to SLm) where short-period communication cannot be performed with each other. The same configurations as those of the second embodiment are denoted by the same reference numerals as those of the second embodiment, and the description thereof will be omitted as appropriate.

### <Relay Device>

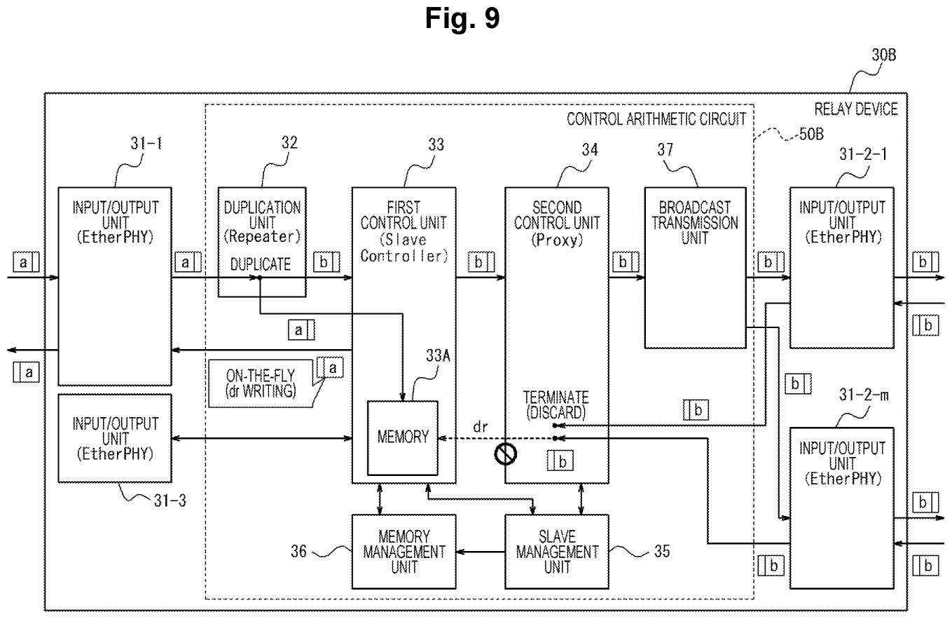

FIG. 9 is a block diagram illustrating a configuration example of the relay device 30B according to the third embodiment. As illustrated in FIG. 9, the relay device 30B includes input/output units 31-1, 31-2 (31-2-1 to 31-2-m), and 31-3, a duplication unit 32, a first control unit 33, a second control unit 34, a slave management unit 35, a memory management unit 36, and a broadcast transmission unit 37. The relay device 30B according to the present embodiment is different from the relay device 30A according to the first embodiment in further including a plurality of the input/output units 31-2 (31-2-1 to 31-2-m) and the broadcast transmission unit 37. The same configurations as those of the second embodiment are denoted by the same reference numerals as those of the second embodiment, and the description thereof will be omitted as appropriate. The duplication unit 32, the first control unit 33, and the second control unit 34, the slave management unit 35, the memory management unit 36, and the broadcast transmission unit 37 constitute a control arithmetic circuit (controller) 50B. The control arithmetic circuit 50B may be constituted by dedicated hardware such as ASIC or FPGA, may be constituted by a processor, or may include both dedicated hardware and a processor.

The broadcast transmission unit 37 duplicates the second communication frame b transmitted from the two or more input/output units 31-2 (31-2-1 to 31-2-m) respectively connected to two or more remote slave devices 40 (40-1 to 40-m) and the second control unit 34, and simultaneously transmits the second communication frame b to each of two or more input/output units 31-2 (31-2-1 to 31-2-m). The broadcast transmission unit 37 duplicates the second communication frames b transmitted via the input/output units 31-2. As illustrated in FIGS. 8 and 9, the relay device 30B includes, for example, the input/output unit 31-2-1 connected to the remote slave device 40-1 and the input/output unit 31-2-2 connected to the remote slave device 40-2. In this case, the broadcast transmission unit 37 duplicates one second communication frame and simultaneously transmits the duplicated second communication frame to the remote slave devices 40-1 and 40-2 via the input/output units 31-2-1 and 31-2-2, respectively.

When receiving the second communication frame b from the remote slave devices 40 (40-1 to 40-m), the second control unit 34 transmits, to the first control unit 33, the data dr written to the second communication frame b, and terminates (discards) the second communication frame b. The second control unit 34 terminates (discards) the second communication frames b corresponding to the number of the input/output units 31-2.

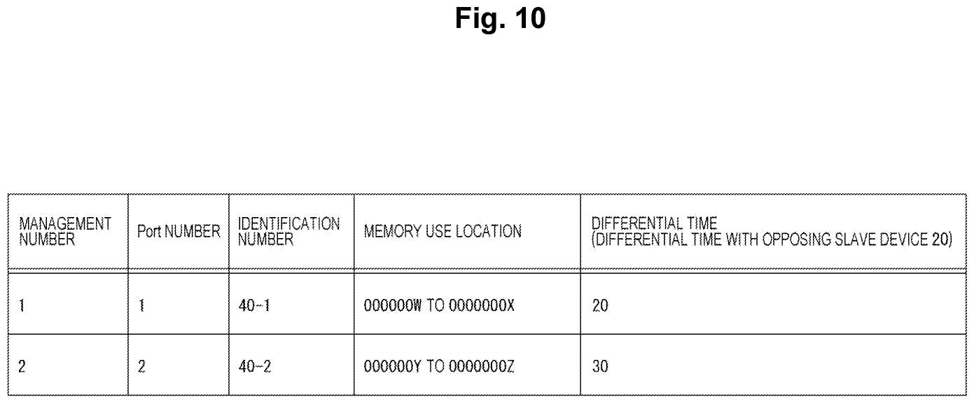

FIG. 10 is a diagram illustrating a database managed by the slave management unit 35 according to the third embodiment. As illustrated in FIG. 10, for example, in a case where two remote slave devices 40-1 and 40-2 are installed, the slave management unit 35 manages each management number, the number of the input/output unit 31-2 (port number), the identification numbers of the remote slave devices 40, the memory use location, and a communication time difference (differential time) with the opposing slave device 20 are managed, but the data to be managed is not limited thereto.

In a case where the differential time is different between the remote slave device 40-1 and the remote slave device 40-2, for example, the number of cycles in which the master device 10 transmits the first communication frame may change in order to perform FB control from each of the remote slave devices 40-1 and 40-2 to the slave device 20-1.

In the data communication system 1B according to the third embodiment, since the relay device 30B includes the slave management unit 35, the memory management unit 36, and the broadcast transmission unit 37, the master device 10 can perform EtherCAT communication with the remote slave devices 40-1 to 40-m even when two or more remote slave devices 40 (40-1 to 40-m) are installed at different installation locations (for example, the slave installation location SL1 and the slave installation location SL2 in FIG. 8).

### Fourth Embodiment

### <Data Communication System>

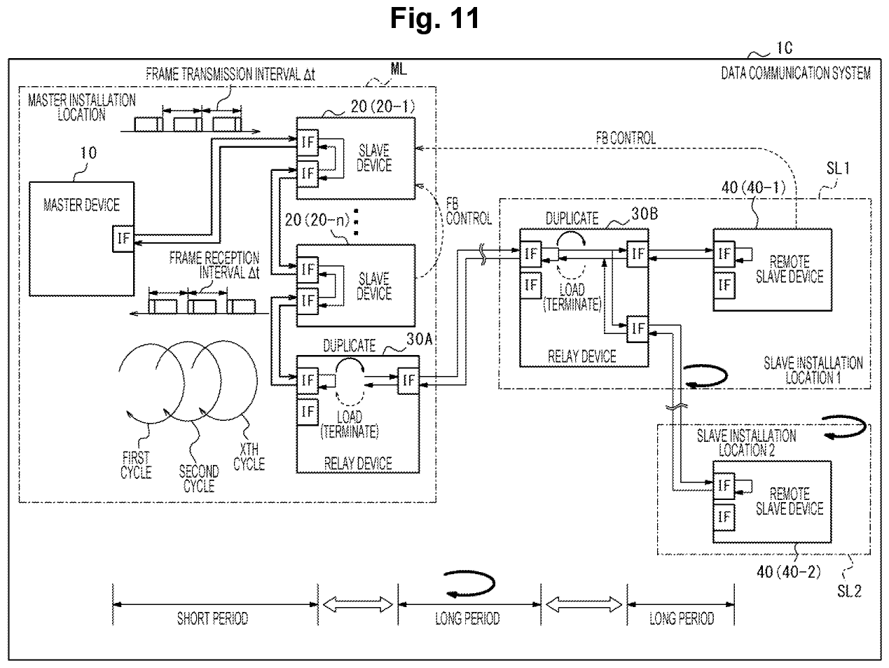

FIG. 11 is a block diagram illustrating a configuration example of a data communication system 1C according to a fourth embodiment. As illustrated in FIG. 11, the data communication system 1C includes a master device 10, slave devices 20 (20-1 to 20-n), a relay device 30A, a relay device 30B, and remote slave devices 40 (40-1 and 40-2). The data communication system 1C according to the present embodiment is different from the data communication system 1B according to the third embodiment in that both the relay device 30A and the relay device 30B are provided. The present embodiment is different from the second embodiment in that the relay device 30A is connected to the relay device 30B instead of being connected to the remote slave device 40-1, but is the same as the second embodiment in that data communication is relayed between two remote slave devices 40-1 and 40-2. The fourth embodiment is different from the third embodiment in that the relay device 30B is installed at the slave installation location SL1 instead of being installed at a master installation location ML, but is the same as the third embodiment in that the relay device 30B relays data communication between two remote slave devices 40-1 and 40-2. However, in the present embodiment, since the relay device 30B and the remote slave device 40-1 are installed at the same location, the communication between the relay device 30B and the remote slave device 40-1 is not long-period communication as in the third embodiment, but short-period communication. Note that FIG. 11 illustrates an example in which two remote slave devices 40-1 and 40-2 are installed at the slave installation locations SL1 and SL2, respectively. However, three or more remote slave devices 40 (40-1 to 40-m) may be installed at locations (slave installation locations SL1 to SLm) where short-period communication cannot be performed with each other. The same configurations as those of the third embodiment are denoted by the same reference numerals as those of the third embodiment, and the description thereof will be omitted as appropriate.

The data communication system 1C according to the fourth embodiment corresponds to an embodiment of a combination of the data communication system 1A according to the second embodiment and the data communication system 1B according to the third embodiment. In the data communication system 1C according to the fourth embodiment, the master device 10 can perform EtherCAT communication with two or more remote slave devices 40 (40-1 to 40-m) installed at more remote installation locations as compared with the second embodiment and the third embodiment.

### Fifth Embodiment

### <Data Communication System>

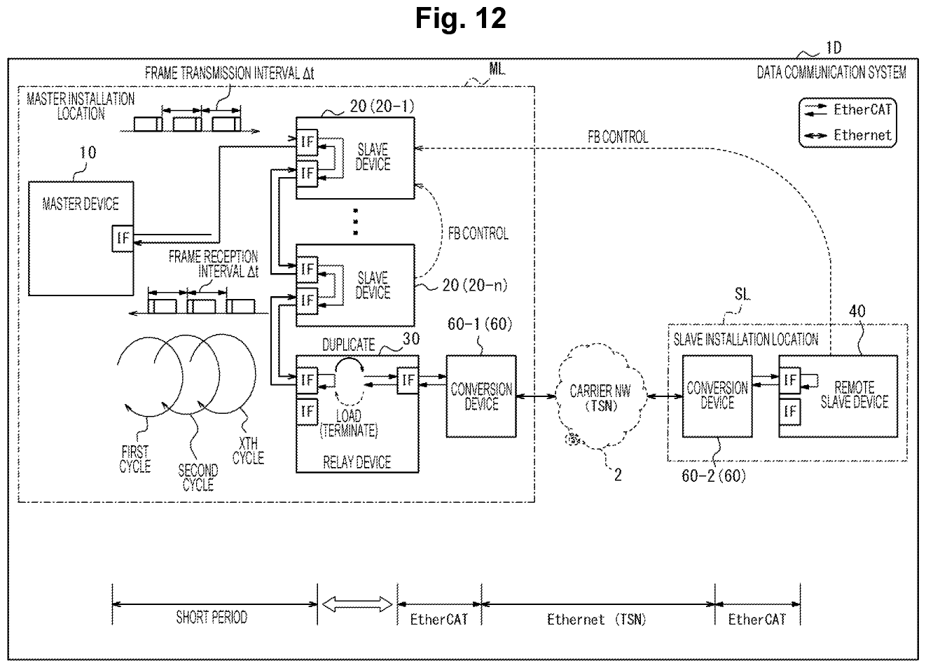

FIG. 12 is a block diagram illustrating a configuration example of a data communication system 1D according to a fifth embodiment. As illustrated in FIG. 12, the data communication system 1D includes a master device 10, slave devices 20 (20-1 to 20-n), a relay device 30, a remote slave device 40, and a pair of conversion devices 60 (60-1 and 60-2). The data communication system 1D according to the present embodiment is different from the data communication system 1 according to the first embodiment in that a pair of the conversion devices 60 (60-1 and 60-2) are connected between the relay device 30 and the remote slave device 40. The same components as those of the first embodiment will be denoted by the same reference signs as those of the first embodiment, and the description thereof will be omitted as appropriate.

As illustrated in FIG. 12, EtherCAT communication (fixed period communication) is performed within a range of the master installation location ML where the master device 10 and the like are disposed and within a range of the slave installation location SL where the remote slave device 40 is disposed. When a carrier network different from EtherCAT such as TSN2 is provided between both the installation locations, EtherCAT communication is divided between the master device 10 and the remote slave device 40. Therefore, by inserting a pair of the conversion devices 60 that convert a network communication protocol at a subsequent stage of the input/output unit 31-2 of the relay device 30 and a preceding stage of the remote slave device 40, EtherCAT communication (fixed period communication) between the master and the slave is secured, and the communication is continued.

### <Conversion Device>

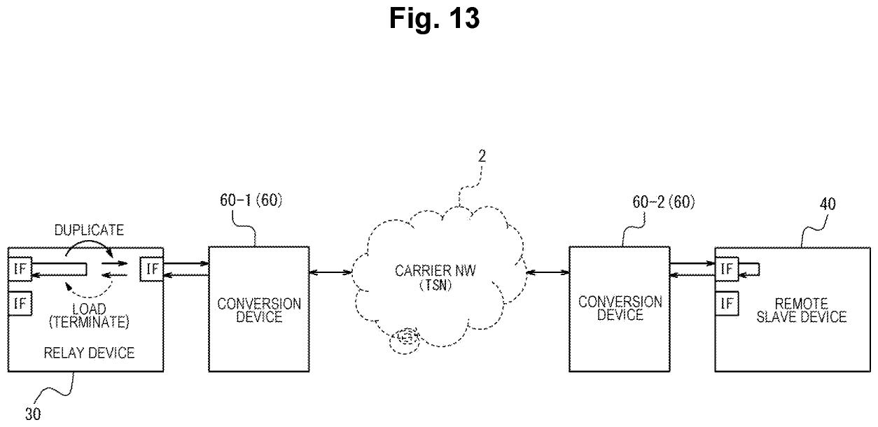

FIG. 13 is a diagram illustrating a conversion device that converts a communication protocol between EtherCAT and TSN. When receiving the second communication frame from the relay device 30 or the remote slave device 40, a pair of the conversion devices 60 (60-1 and 60-2) convert the frame format of the second communication frame from the frame format of EtherCAT communication into the frame format of a predetermined network capable of time synchronization communication, and transmits the second communication frame to the predetermined network. Moreover, when receiving the second communication frame from the predetermined network, a pair of the conversion devices 60 (60-1 and 60-2) convert the frame format of the second communication frame from the frame format of the predetermined network into the frame format of EtherCAT communication, and transmits the second communication frame to the relay device 30 or the remote slave device 40. The predetermined network is, for example, a communication network of Ethernet (registered trademark) capable of time synchronization communication, such as Time-Sensitive Networking (TSN), but is not limited to TSN. TSN is a network technology for interoperating an industrial network extending the standard Ethernet and an IT network. TSN is a network standard in which time synchronization is guaranteed on the basis of Ethernet and a real-time property can be secured.

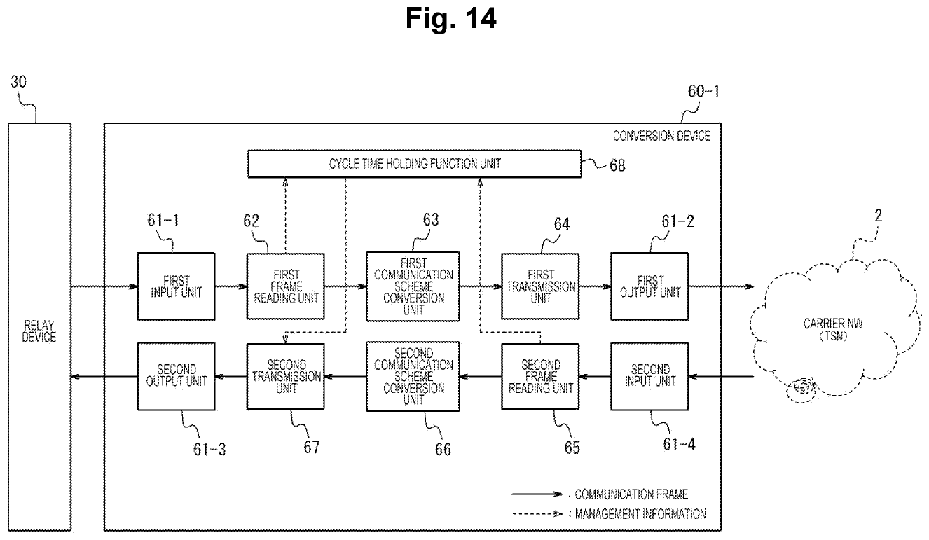

FIG. 14 is a block diagram illustrating a configuration example of a pair of the conversion devices 60. As illustrated in FIG. 14, the conversion device 60-1 includes a first input unit 61-1, a first frame reading unit 62, a first communication scheme conversion unit 63, a first transmission unit 64, a first output unit 61-2, a second input unit 61-3, a second frame reading unit 65, a second communication scheme conversion unit 66, a second transmission unit 67, a second output unit 61-4, and a cycle time holding function unit 68. As illustrated in FIG. 14, for example, the conversion device 60-1 transmits an Internet frame (communication frame) received from the relay device 30 to TSN via the first input unit 61-1, the first frame reading unit 62, the first communication scheme conversion unit 63, the first transmission unit 64, and the first output unit 61-2. Then, the conversion device 60-1 transmits, for example, the communication frame received from TSN to the relay device 30 via the second input unit 61-3, the second frame reading unit 65, the second communication scheme conversion unit 66, the second transmission unit 67, and the second output unit 61-4. Since the conversion device 60-2 has the same function and configuration as the conversion device 60-1, the description thereof is omitted.

The first input unit 61-1 is an input port for inputting a communication frame from the relay device 30. The first input unit 61-1 includes a physical layer transceiver device (EtherPHY) for transmitting and receiving a communication frame.

The first frame reading unit 62 reads the data written to the received communication frame from the relay device 30 via the first input unit 61-1. The first frame reading unit 62 transmits the time information of the communication frame and the communication information to the cycle time holding function unit 68.

The first communication scheme conversion unit 63 converts the communication protocol from EtherCAT to Ethernet. The communication protocol conversion is necessary to transmit the communication frame received from the relay device 30 to the remote slave device 40 via TSN2 having a communication scheme different from that of EtherCAT.

The first transmission unit 64 transmits the communication frame received from the relay device 30 to TSN2 via the first output unit 61-2 according to the communication protocol of Ethernet (TSN).

The first output unit 61-2 is an output port that outputs the communication frame from the conversion device 60-1 to TSN2. The first output unit 61-2 includes a physical layer transceiver device (EtherPHY) for transmitting and receiving a communication frame.

The second input unit 61-3 is an input port for inputting the communication frame from TSN2. The first input unit 61-1 includes a physical layer transceiver device (EtherPHY) for transmitting and receiving a communication frame.

The second frame reading unit 65 reads the data written to the communication frame received from TSN2 via the second input unit 61-3. The second frame reading unit 65 transmits the time information of the communication frame and the communication information to the cycle time holding function unit 68.

The second communication scheme conversion unit 66 converts the communication protocol from Ethernet to EtherCAT. The communication protocol conversion is necessary to transmit the communication frame received from TSN2 to the relay device 30 via EtherCAT having a communication scheme different from that of Ethernet.

The second transmission unit 67 transmits the communication frame received from TSN2 to the relay device 30 via the second output unit 61-4 according to the communication protocol of EtherCAT.

The second output unit 61-4 is an output port that outputs the communication frame from the conversion device 60-1 to the relay device 30. The second output unit 61-4 includes a physical layer transceiver device (EtherPHY) for transmitting and receiving a communication frame.

The cycle time holding function unit 68 receives the time information of the communication frame and the communication information from the first frame reading unit 62 and the second frame reading unit 65, and provides an instruction of the communication cycle time to the second transmission unit 67. The communication cycle time refers to, for example, a time taken to process data communication with the relay device 30 or the remote slave device 40 and then process data communication with the same device again.

In the data communication system 1D according to the fifth embodiment, in a case where the EtherCAT communication between the master and the slave of the data communication system 1 according to the first embodiment is divided by providing a carrier network such as TSN, a pair of the conversion devices 60 convert the communication protocol between EtherCAT and Ethernet. Therefore, the master device 10 can perform the EtherCAT communication with the remote slave device 40 across the carrier network such as TSN.

### Sixth Embodiment

### <Data Communication System>

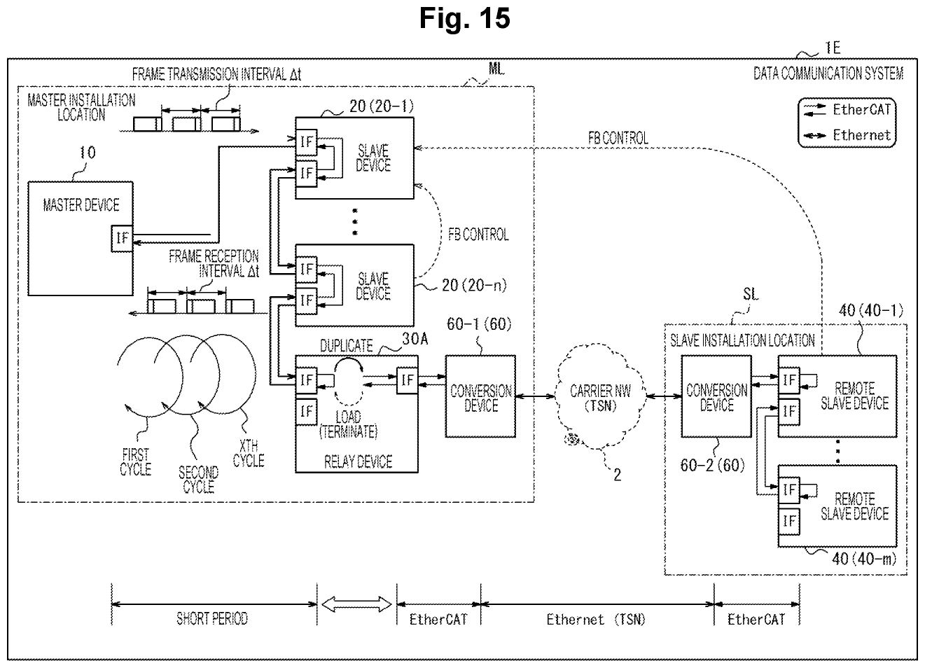

FIG. 15 is a block diagram illustrating a configuration example of a data communication system 1E according to a sixth embodiment. As illustrated in FIG. 15, the data communication system 1E includes a master device 10, slave devices 20 (20-1 to 20-n), a relay device 30A, remote slave devices 40 (40-1 to 40-m), and a pair of conversion devices 60 (60-1 and 60-2). The data communication system 1E according to the present embodiment is different from the data communication system 1A according to the second embodiment in that a pair of the conversion devices 60 (60-1 and 60-2) are connected between the relay device 30A and the remote slave devices 40 (40-1 to 40-m). The same configurations as those of the second embodiment are denoted by the same reference numerals as those of the second embodiment, and the description thereof will be omitted as appropriate.

As illustrated in FIG. 15, the data communication system 1E according to the present embodiment inserts a pair of the conversion devices 60 that convert a communication protocol of a network into a subsequent stage of the input/output unit 31-2 of the relay device 30A and a preceding stage of the input/output unit of the remote slave device 40-1 of the data communication system 1A according to the second embodiment, and secures EtherCAT communication (fixed period communication) between the master and the slave to continue the communication.

In the data communication system 1E according to the sixth embodiment, in a case where the EtherCAT communication between the master and the slave of the data communication system 1A according to the second embodiment is divided by providing a carrier network such as TSN, a pair of the conversion devices 60 convert the communication protocol between EtherCAT and Ethernet. Therefore, the master device 10 can perform the EtherCAT communication with the remote slave device 40 across the carrier network such as TSN.

### Seventh Embodiment

### <Data Communication System>

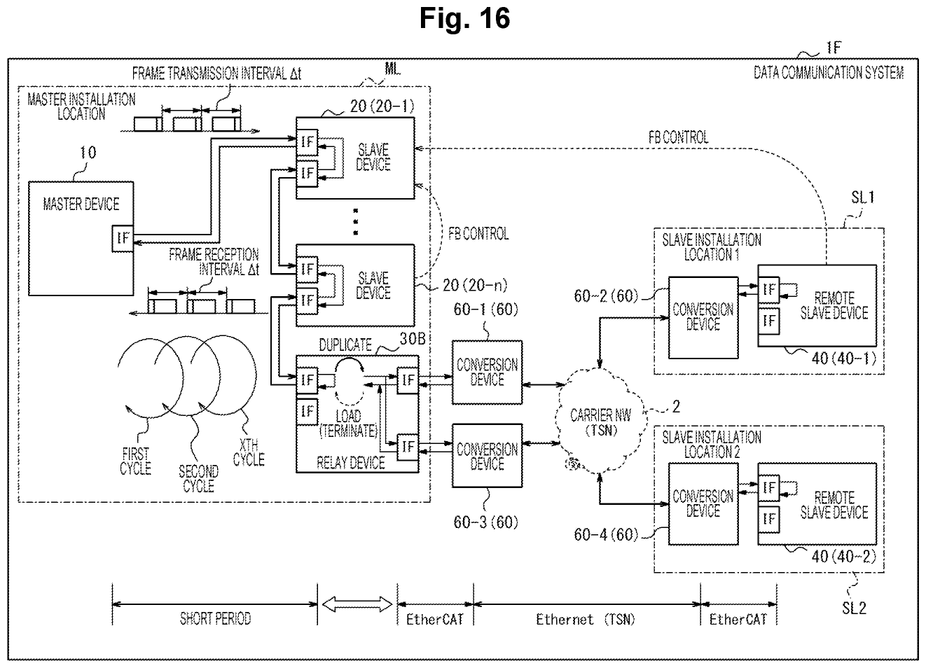

FIG. 16 is a block diagram illustrating a configuration example of a data communication system 1F according to a seventh embodiment. As illustrated in FIG. 16, the data communication system 1F includes a master device 10, slave devices 20 (20-1 to 20-n), a relay device 30B, remote slave devices 40 (40-1 and 40-2), and a pair of conversion devices 60 (60-1 and 60-2) and (60-3 and 60-4). The data communication system 1F according to the present embodiment is different from the data communication system 1B according to the third embodiment in that a pair of the conversion devices 60 (60-1, 60-2, 60-3, and 60-4) are connected between the relay device 30B and the remote slave devices 40 (40-1 and 40-2). The same configurations as those of the third embodiment are denoted by the same reference numerals as those of the third embodiment, and the description thereof will be omitted as appropriate.

As illustrated in FIG. 16, the data communication system 1F according to the present embodiment inserts each of a pair of the conversion devices 60 that convert a communication protocol of a network into a subsequent stage of the input/output unit 31-2-1 of the relay device 30B and a preceding stage of the input/output unit of the remote slave device 40-1 of the data communication system 1B according to the third embodiment, and into a subsequent stage of the input/output unit 31-2-2 of the relay device 30B and a preceding stage of the input/output unit of the remote slave device 40-2, and secures EtherCAT communication (fixed period communication) between the master and the slave to continue the communication.

In the data communication system 1F according to the seventh embodiment, in a case where the EtherCAT communication between the master and the slave of the data communication system 1B according to the third embodiment is divided by providing a carrier network such as TSN, a pair of the conversion devices 60 convert the communication protocol between EtherCAT and Ethernet. Therefore, the master device 10 can perform the EtherCAT communication with the remote slave device 40 across the carrier network such as TSN.

### Eighth Embodiment

### <Data Communication System>

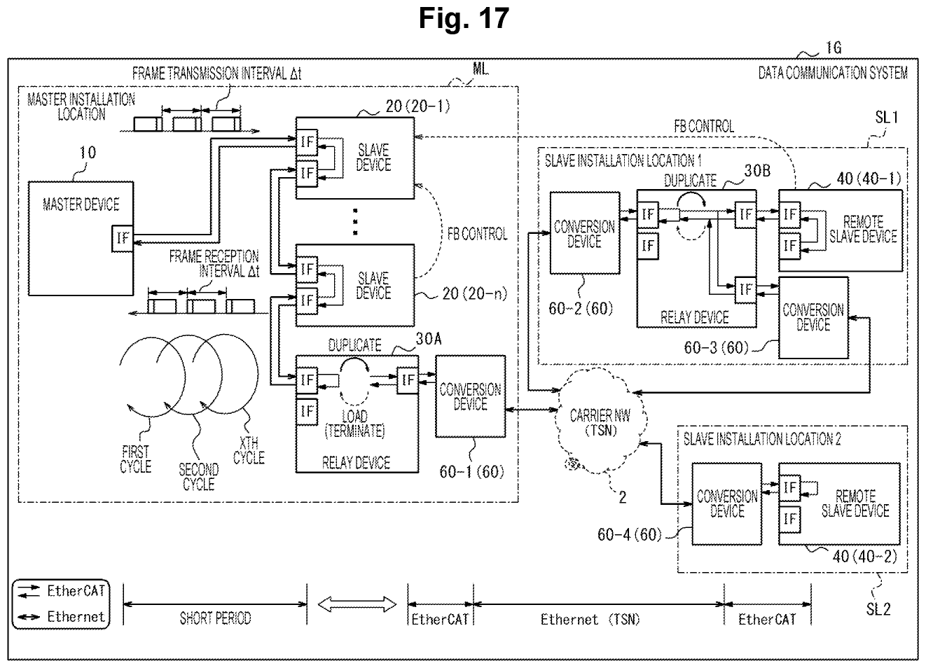

FIG. 17 is a block diagram illustrating a configuration example of a data communication system 1G according to an eighth embodiment. As illustrated in FIG. 17, the data communication system 1G includes a master device 10, slave devices 20 (20-1 to 20-n), a relay device 30A, a relay device 30B, remote slave devices 40 (40-1 and 40-2), and pairs of conversion devices 60 (60-1 and 60-2) and (60-3 and 60-4). The data communication system 1G according to the present embodiment is different from the data communication system 1C according to the fourth embodiment in that each pair of the conversion devices 60 are connected between the relay device 30A and the relay device 30B and between the relay device 30B and the remote slave devices 40 (40-1 and 40-2). The same configurations as those of the fourth embodiment are denoted by the same reference numerals as those of the fourth embodiment, and the description thereof will be omitted as appropriate.

As illustrated in FIG. 17, the data communication system 1G according to the present embodiment inserts each pair of the conversion devices 60 that convert a communication protocol of a network into a subsequent stage of the input/output unit 31-2 of the relay device 30A and a preceding stage of the input/output units 31-1 of the relay device 30B of the data communication system 1C according to the fourth embodiment, into a subsequent stage of the input/output unit 31-2 of the relay device 30B and a preceding stage of the input/output unit of the remote slave device 40-1, and into a subsequent stage of the input/output unit 31-2-2 of the relay device 30B and a preceding stage of the input/output unit of the remote slave device 40-2, and secures EtherCAT communication (fixed period communication) between the master and the slave to continue the communication.

In the data communication system 1G according to the eighth embodiment, in a case where the EtherCAT communication between the master and the slave of the data communication system 1C according to the fourth embodiment is divided by a carrier network such as TSN, a pair of the conversion devices 60 convert the communication protocol between EtherCAT and Ethernet. Therefore, the master device 10 can perform the EtherCAT communication with the remote slave device 40 across the carrier network such as TSN.

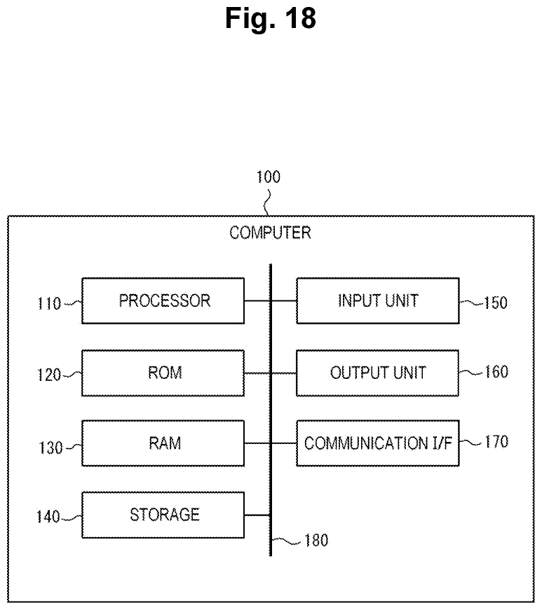

In order to cause the relay devices 30, 30A, and 30B described above to function, a computer capable of executing a program instruction can be used. FIG. 18 is a block diagram illustrating a schematic configuration of the computer that functions as the relay devices 30, 30A, and 30B. Here, the computer functioning as the relay devices 30, 30A, and 30B may be a general-purpose computer, a dedicated computer, a workstation, a personal computer (PC), an electronic notebook pad, or the like. The program instruction may be a program code, a code segment, or the like, for executing a necessary task.

As illustrated in FIG. 18, the computer 100 includes a processor 110, a read only memory (ROM) 120, a random access memory (RAM) 130, and a storage 140 as storage units, an input unit 150, an output unit 160, and a communication interface (I/F) 170. The components are communicably connected to each other via a bus 180.

The ROM 120 stores various kinds of programs and various kinds of data. The RAM 130 temporarily stores a program or data as a working area. The storage 140 is constituted by a hard disk drive (HDD) or a solid state drive (SSD) and stores various kinds of programs including an operating system and various kinds of data. In the present disclosure, the program according to the present disclosure is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like, and may be constituted by the same or different types of plurality of processors. The processor 110 reads a program from the ROM 120 or the storage 140 and executes the program by using the RAM 130 as a working area to perform control of each of the above-described components and various kinds of arithmetic processing. Note that at least part of these processing content may be implemented by hardware.

The program may be recorded in a recording medium readable by the relay devices 30, 30A, and 30B. By using such a recording medium, the recording medium can be installed in the relay devices 30, 30A, and 30B. Here, the recording medium on which the program is recorded may be a non-transitory recording medium. The non-transitory recording medium is not particularly limited, but may be, for example, a CD-ROM, a DVD-ROM, a Universal Serial Bus (USB) memory, or the like. Furthermore, the program may be downloaded from an external device via a network.

With regard to the above-described embodiments, the following supplementary items are further disclosed.

(Supplementary note 1)

A data communication system that extends a communication distance in EtherCAT communication, the data communication system including:
a master device that transmits a first communication frame in which data is stored to a slave device or a relay device in a first communication period;
the slave device that reads and writes the data from and to the first communication frame and transmits the first communication frame to the master device, the slave device at a lower stage, or the relay device;
the relay device that is connected to a preceding stage or a subsequent stage of the slave device, creates a second communication frame obtained by duplicating the first communication frame received from the master device or the slave device, reads and writes the data from and to the second communication frame, matches an absolute time of the relay device in the first communication period with an absolute time of a remote slave device in a second communication period, transmits the second communication frame to the remote slave device in the second communication period, loads the data written to the second communication frame received by the remote slave device in the second communication period into the first communication frame, and transmits the first communication frame to the master device or the slave device in the first communication period; and
the remote slave device that reads and writes the data from and to the second communication frame received from the relay device, and returns the second communication frame to the relay device.

(Supplementary note 2)

The data communication system according to Supplementary note 1, further including
a pair of conversion devices that convert a frame format of the second communication frame from a frame format of the EtherCAT communication into a frame format of a predetermined network capable of time synchronization communication, and transmit the second communication frame to the predetermined network when receiving the second communication frame from the relay device or the remote slave device, and
convert the frame format of the second communication frame from the frame format of the predetermined network into the frame format of the EtherCAT communication and transmit the second communication frame to the relay device or the remote slave device when receiving the second communication frame from the predetermined network.

(Supplementary note 3)

A relay device that relays communication in the relay device including
a controller that creates a second communication frame obtained by duplicating received first communication frame,
reads and writes data stored in the second communication frame, matches an absolute time of the relay device in a first communication period with an absolute time of a remote slave device in a second communication period, loads the data written to the second communication frame received from the remote slave device in the second communication period into the first communication frame, and transmits the first communication frame to a master device or a slave device in the first communication period.

(Supplementary note 4)

The relay device according to Supplementary note 3,
in which the controller further transmits and receives the second communication frame to and from the remote slave device in the second communication period instead of the slave device that transmits and receives the data in the first communication period.

(Supplementary note 5)

The relay device according to Supplementary note 4,
in which the controller is further connected to two or more remote slave devices, manages a memory use location on a memory assigned to each of the two or more remote slave devices, and writes and reads data received from each of the two or more remote slave devices at the memory use location on the memory.

(Supplementary note 6)

The relay device according to Supplementary note 5, further including
two or more interfaces that are respectively connected to the two or more remote slave devices,
in which the controller further duplicates the second communication frame and simultaneously transmits the second communication frame to each of the two or more interfaces.

(Supplementary note 7)

A data communication method for extending a communication distance in EtherCAT communication, the data communication method including:
by a master device, transmitting a first communication frame in which data is stored to a slave device or a relay device in a first communication period;
by the slave device, reading and writing the data from and to the first communication frame;
by the slave device, transmitting the first communication frame to the master device, the slave device at a subsequent stage, or the relay device;
by the relay device, creating a second communication frame obtained by duplicating the first communication frame received from the master device or the slave device;
by the relay device, reading and writing the data from and to the second communication frame;
by the relay device, matching an absolute time of the relay device in the first communication period with an absolute time of a remote slave device in a second communication period;
by the relay device, transmitting the second communication frame to the remote slave device in the second communication period;
by the remote slave device, reading and writing the data from and to the second communication frame received from the relay device;
by the remote slave device, returning the second communication frame to the relay device; and
by the relay device, loading the data written to the second communication frame received by the remote slave device in the second communication period into the first communication frame, and transmitting the first communication frame to the master device or the slave device in the first communication period.

(Supplementary note 8)

A relay method for relaying communication in the relay method including:
by a relay device,
creating a second communication frame obtained by duplicating received first communication frame;
reading and writing data stored in the second communication frame;
matching an absolute time of the relay device in a first communication period with an absolute time of a remote slave device in a second communication period; and
loading the data written to the second communication frame received from the remote slave device in the second communication period into the first communication frame, and transmitting the first communication frame to a master device or a slave device in the first communication period.

(Supplementary note 9)

The relay method according to Supplementary note 8, including
transmitting and receiving the second communication frame to and from the remote slave device in the second communication period instead of the slave device that transmits and receives the data in the first communication period.

(Supplementary note 10)

A non-transitory storage medium storing a program that is executable by a computer, the program causing the computer to function as the relay device according to any one of Supplementary notes 3 to 6.

Although the above-described embodiment has been described as the representative example, it is apparent to those skilled in the art that many changes and substitutions can be made within the spirit and scope of the present disclosure. Therefore, it should not be understood that the present disclosure is limited by the above embodiment, and various modifications or changes can be made without departing from the scope of the claims. For example, a plurality of configuration blocks described in the configuration diagram of the embodiment can be combined into one, or one configuration block can be divided.

For example, the duplication unit 32 and the first control unit 33 of the relay device 30, and the second control unit 34 may be constituted by separate devices.

### REFERENCE SIGNS LIST

1, 1A, 1B, 1C, 1D, 1E, 1F, 1G Data communication system
2 Carrier network (TSN)
10 Master device
20 (20-1 to 20-n) Slave device
30, 30A, 30B Relay device (proxy slave)
31, 31-1, 31-2, 31-2-1 to 31-2-m, 31-3 Input/output unit (interface)
32 Duplication unit (repeater)
33 First control unit (slave controller)
33A Memory
34 Second control unit (Proxy)
35 Slave management unit
36 Memory management unit
37 Broadcast transmission unit
40, 40-1 to 40-m Remote slave device
50, 50A, 50B Control arithmetic circuit (controller)
60, 60-1 to 60-4 Conversion device
100 Computer
110 Processor
120 ROM
130 RAM
140 Storage
150 Input unit
160 Output unit
170 Communication interface (I/F)
180 Bus

1. A data communication system for extending a communication distance in EtherCAT communication, the data communication system comprising:
a master device that transmits a first communication frame in which data is stored to a slave device or a relay device in a first communication period;
the slave device that reads and writes the data from and to the first communication frame and transmits the first communication frame to the master device, the slave device at a lower stage, or the relay device;
the relay device that is connected to a preceding stage or a subsequent stage of the slave device, creates a second communication frame obtained by duplicating the first communication frame received from the master device or the slave device, reads and writes the data from and to the second communication frame, matches an absolute time of the relay device in the first communication period with an absolute time of a remote slave device in a second communication period, transmits the second communication frame to the remote slave device in the second communication period, loads the data written to the second communication frame received by the remote slave device in the second communication period into the first communication frame, and transmits the first communication frame to the master device or the slave device in the first communication period; and
the remote slave device that reads and writes the data from and to the second communication frame received from the relay device, and returns the second communication frame to the relay device.

2. The data communication system according to claim 1, further comprising
a pair of conversion devices that convert a frame format of the second communication frame from a frame format of the EtherCAT communication into a frame format of a predetermined network capable of time synchronization communication, and transmit the second communication frame to the predetermined network when receiving the second communication frame from the relay device or the remote slave device, and
convert the frame format of the second communication frame from the frame format of the predetermined network into the frame format of the EtherCAT communication and transmit the second communication frame to the relay device or the remote slave device when receiving the second communication frame from the predetermined network.

3. A relay device for relaying communication in different communication periods in EtherCAT communication, the relay device comprising:
a duplication unit that creates a second communication frame obtained by duplicating received first communication frame; and
a first control unit that reads and writes data stored in the second communication frame, matches an absolute time of the relay device in a first communication period with an absolute time of a remote slave device in a second communication period, loads the data written to the second communication frame received from the remote slave device in the second communication period into the first communication frame, and transmits the first communication frame to a master device or a slave device in the first communication period.

4. The relay device according to claim 3, further comprising
a second control unit that transmits and receives the second communication frame to and from the remote slave device in the second communication period instead of the slave device that transmits and receives the data in the first communication period.

5. The relay device according to claim 4, further comprising:
a slave management unit that is connected to two or more remote slave devices, manages a memory use location on a memory assigned to each of the two or more remote slave devices; and
a memory management unit that instructs the first control unit to write and read data received from each of the two or more remote slave devices at the memory use location on the memory.

6. The relay device according to claim 5, further comprising:
two or more input/output units that are respectively connected to the two or more remote slave devices; and
a broadcast transmission unit that duplicates the second communication frame transmitted from the second control unit and simultaneously transmits the second communication frame to each of the two or more input/output units.

7. A data communication method for extending a communication distance in EtherCAT communication, the data communication method comprising:
transmitting, by a master device, a first communication frame in which data is stored to a slave device or a relay device in a first communication period;
reading and writing, by the slave device, the data from and to the first communication frame;
transmitting, by the slave device, the first communication frame to the master device, the slave device at a subsequent stage, or the relay device;
creating, by the relay device, a second communication frame obtained by duplicating the first communication frame received from the master device or the slave device;
reading and writing, by the relay device, the data from and to the second communication frame;
matching, by the relay device, an absolute time of the relay device in the first communication period with an absolute time of a remote slave device in a second communication period;
transmitting, by the relay device, the second communication frame to the remote slave device in the second communication period;
reading and writing, by the remote slave device, the data from and to the second communication frame received from the relay device;
returning, by the remote slave device, the second communication frame to the relay device;
loading, by the relay device, the data written to the second communication frame received by the remote slave device in the second communication period into the first communication frame; and
transmitting, by the relay device, the first communication frame to the master device or the slave device in the first communication period.

8. A relay method for relaying communication in different communication periods in EtherCAT communication, the relay method comprising:
creating, by a relay device, a second communication frame obtained by duplicating received first communication frame;
reading and writing, by the relay device, data stored in the second communication frame;
matching, by the relay device, an absolute time of the relay device in a first communication period with an absolute time of a remote slave device in a second communication period;
loading, by the relay device, the data written to the second communication frame received from the remote slave device in the second communication period into the first communication frame; and
transmitting, by the relay device, the first communication frame to a master device or a slave device in the first communication period.

9. The relay method according to claim 8, further comprising
transmitting and receiving, by the relay device, the second communication frame to and from the remote slave device in the second communication period instead of the slave device that transmits and receives the data in the first communication period.

10. A computer-readable non-transitory recording medium storing computer-executable program instructions that when executed by a processor cause a computer to execute a method comprising:
creating, by a duplication unit, a second communication frame obtained by duplicating received first communication frame;
reading and writing, by a first control unit, data stored in the second communication frame;
matching, by the first control unit, an absolute time of a relay device in a first communication period with an absolute time of a remote slave device in a second communication period;
loading, by the first control unit, the data written to the second communication frame received from the remote slave device in the second communication period into the first communication frame; and
transmitting, by the first control unit, the first communication frame to a master device or a slave device in the first communication period.

11. The computer-readable non-transitory recording medium according to claim 10, the method further comprising:
transmitting and receiving, by a second control unit, the second communication frame to and from the remote slave device in the second communication period instead of the slave device that transmits and receives the data in the first communication period.

12. The computer-readable non-transitory recording medium according to claim 11, the method further comprising:
managing, by a slave management unit that is connected to two or more remote slave devices, a memory use location on a memory assigned to each of the two or more remote slave devices; and
instructing, by a memory management unit, the first control unit to write and read data received from each of the two or more remote slave devices at the memory use location on the memory.

13. The computer-readable non-transitory recording medium according to claim 12, the method further comprising:
duplicating, by a broadcast transmission unit, the second communication frame transmitted from the second control unit; and
simultaneously transmitting, by the broadcast transmission unit, the second communication frame to each of two or more input/output units that are respectively connected to the two or more remote slave devices.
